(19) United States
(12) Patent Application Publication
(10) Pub. No.: US 2001/0036224 A1
(43) Pub. Date: Nov. 1, 2001

(54) System and method for the delivery of targeted data over wireless networks

(76) Inventors: Aaron Demello, Montreal (CA); Alexander Miller, Montreal (CA); Alexandre Legendre, Montreal (CA); Gerald Host, Montreal (CA)

Correspondence Address: McDERMOTT, WILL & EMERY, 600, 13th Street North-West, Washington, DC, 20005-3096, US

(21) Appl. No.: 09/778,108

(22) Filed: Feb. 7, 2001

(30) Foreign Application Priority Data
Feb. 7, 2000 (CA) 2,298,194

(51) Int. Cl. H04B 1/38; H04L 5/16

(52) U.S. Cl. 375/220

(57) ABSTRACT

The present invention relates to a system and method for the passive location positioning of wireless handsets for the purposes of delivering targeted data to users in a wireless communications network while protecting the privacy of the users. The network may contain a plurality of clusters comprising at least two physical nodes communicating with each other via a remote link. The first node, the Mediation Server, receives raw location positioning data from the wireless communications network and sends standardized location positioning data with encrypted unique identifiers to the second node, the Profiling Server. The Profiling Server tracks and profiles current and historical location positioning data, compiling databases of anonymous user profiles to permit targeting of personalized and relevant data. The Profiling Server targets data to users with matching profiles and forwards those messages to the Mediation Server for encryption and further message compilation and transport. Privacy is achieved by separation of data collection and message transmission functions from the profiling and targeting functions. The present invention also concerns a method of anonymizing data related to a wireless transceiver.

### FIELD OF THE INVENTION

The present invention relates to a system and method for the delivery of targeted data over wireless networks. More specifically, the present invention relates to systems and methods for the delivery of targeted data to wireless users and in particular relates to a system that assures the integrity and confidentiality of personal information relating to wireless users. Herein, targeted data includes advertising, alerts, messages, images and any other type of information or content that may be targeted to a class or group of persons, that may be delivered in text, video or graphic formats and also includes applications.

The present invention also relates to systems and methods of collecting information about users for the purpose of making inferences about their demographic, psychographic and behavioral or habitual characteristics that may be used for advertising, marketing and other commercial applications.

### BACKGROUND OF THE INVENTION

Wireless telecommunications networks allow communications between wireless transceivers. Wireless transceivers include the following devices: wireless handsets, mobile phones, personal digital assistants (PDAs), pagers, data transmission enabled terminals, and the like, that generally use radio frequency signals.

In a wireless communications network, such as a cellular network, wireless users communicate sharing common resources. A wireless transceiver may connect to the wireless network through a group of network components that include a Base Station Transceiver (BST) or a Base Station Controller (BSC) or a Base Station (BS), or a combination thereof. In the context of the present description, all these components will be referred to as “BS”. The individual BSs define individual cells within the wireless communications network. Each BS continuously communicates with a wireless transceiver over radio communications channels to exchange messages. The communications messages include, among other things, user registration event, call hand-off events, location area events, and the like, to offer telecommunications services to the wireless users regardless of their location positioning in the wireless network. Telecommunications standards including TDMA, CDMA, GSM, PDC, and UMTS support different variants of those messages, enabling the ability of the wireless network to make a determination of the location of a wireless transceiver. This is done through the identification of the cell/sector ID where the wireless transceiver is registered. Other location determination technologies may be integrated with the wireless communications network to make a more accurate determination of the location of a wireless transceiver through Global Positioning System (GPS), Time of Arrival (TOA), Angle of Arrival (AOA), or combinations thereof.

Wireless communications networks have the capability to track positioning of wireless transceivers in the wireless communications network using databases such as Home Location Register (HLR) and Visitor Location Register (VLR), where the VLR and HLR keep track of user positioning in the Service Area and Network Area, respectively.

A wireless communications network differentiates wireless users and associates with them wireless transceivers using a number of unique identifiers including Mobile Identification Number (MIN), International Mobile Station Identity (IMSI), Mobile Station Integrated Digital Service Number (MSISDN), Mobile Directory Number (MDN), Electronic Ser. Number (ESN), Manufacture's Code (MAN), Station Class Mark (SCM), and the like. Wireless communications networks use these identifiers to associate different network activities and network events with specific wireless transceivers. These identifiers may be assigned to the wireless transceivers upon the subscription of a wireless user to the wireless service. Some identifiers used by wireless networks to identify wireless users or wireless transceivers may not be unique. However, when used in combination, these identifiers may establish the unique identity of a given wireless transceiver.

In recent years, a number of location-based systems have been implemented for wireless networks. Such systems may provide services or delivery information to the wireless transceiver that may be based on their relevance to the particular location or profile of the wireless user, or a combination thereof.

Examples of such existing or future applications include location specific and time sensitive information services, telephone directories and city guides. In such applications, information delivered to a wireless transceiver may be tailored to the current location of the user of the wireless transceiver. This information is generally provided to wireless users in response to a user request for an information service that is placed over a wireless transceiver.

The information in such systems is delivered to the wireless transceiver based on user requests. This method does not allow the delivery of content to the wireless user when it might be most useful and relevant to the wireless user. Examples of such useful and relevant information includes traffic alerts, marketing messages, advertising, news alerts and the like.

To improve the relevance of the content, location-based applications may rely upon a profile of the wireless user. User profiling information may help application services provide personalized content to users. The user profile may be created based on personal information voluntarily provided by wireless users that complete a survey or answer a questionnaire. This type of user profile may be limited because it may not be relevant to the context of the current activities and location of the wireless user.

Other systems may build user profiles based on observations of user activities over a period of time. Such profiles may consist of descriptions indicating user properties and preferences that may be inferred from monitored and recorded user activities. Examples of such profiles include Internet profiles, consisting of the user demographics and psychographics inferred through the historical tracking of user activities over the Internet, including some or all of the following aspects: number of user sessions, time of user session, sites visited, purchasing habits, and the like. These types of profiles may not allow the monitoring of user behavior in the real world since the profiling may be limited to the analysis of users patterns and habits in the virtual world of the Internet.

A wireless transceiver may be used as a personal and portable device that may be carried by users on a continuous basis. This suggests that the location positioning that is provided through the wireless transceiver may correspond to the location positioning of users and may be used to improve or create demographic and psychographic user profiles. The location positioning of users may provide information about some or all of the following: personal and household income, lifestyle preferences, purchasing habit, travel patterns, place of work, place of residence, work related activities, personal activities, and the like.

These user profiles can then be used for many purposes, including the delivery of personalized and relevant content to wireless users. This ability to target the right person at the right place and the right time may constitute an efficient content delivery mechanism.

One of the very informative sources of information to be used for the targeting of information is the historical tracking of a user's whereabouts and instantaneous geographical positioning of the wireless user. The physical location of a user in a geographical area covered by a wireless network may provide information about the personal interests, tastes, activities and habits of such user. This information can be used to deliver relevant and personalized content to wireless users. This information can also be used to create groups of users and allow to target what kind of information the wireless users would be interested in receiving. Historical location positioning enables segmentation of wireless users according to the visiting locations and wireless user's location positioning patterns.

The wireless communications network may output user location positioning to external applications for billing/charging purposes, fraud detection systems, emergency calls, lawfully authorized user activity monitoring, and enabling value added services. Typically, wireless networks provide user location information application external to wireless networks with accuracy down to a network cell/sector size via a variety of vendor specific and standardized interfaces including Mobile Positioning Center (MPC), Mobile Internet Gateway (MIG), Billing and Call Detail Records (CDR) data streams, IS-41, IS-124, and others. A number of emerging location positioning technologies such as GPS, TOA, AOA and the like may foster more precise location specific targeting.

User location positioning contains many private and personal characteristics. This information can be used to determine the location and timing of the movements of wireless users in a network. Therefore, it is important for the systems tracking user location and time to protect the privacy of wireless users.

Wireless operators offer SMS service, enabling the exchange of alphanumeric messages between wireless users and message centers. Wireless operators also offer WAP or similar services giving advantage of full Internet access over wireless transceivers enabling distribution of graphics, audio and video and multimedia type of information.

All of the above factors and phenomena being present in the prior art can be used to create a new phenomenon that may enable the delivery of highly targeted data over wireless communications networks to wireless users via wireless transceivers independent of an active user request. In particular, location positioning methods may be used in the context of user position tracking, static telemetry and information services. SMS and WAP channels may be used to deliver targeted data to wireless users. Also, there may be various security methods used on the Internet and wireless networks for privacy and authentication purposes. However, there is no system or method to combine all of these components to enable targeted data delivery and profiling using continuous tracking of user location positioning in the wireless network free of user privacy issues.

### SUMMARY OF THE INVENTION

It is an object of the present invention to overcome disadvantages of the prior art by offering a method and a system that enables the delivery of targeted data to users of wireless transceivers based on user location positioning. It is another object of the present invention to provide a method and a system for the filtering and storing of user location positioning without violating the privacy of wireless users. In accordance with the invention this object is achieved with a method for anonymizing data from wireless transceivers comprising the steps of:

obtaining data related to said wireless transceiver;

substituting said unique identifier with an anonymous identifier; and creating a record of said data associated with said anonymous identifier.

In accordance with the invention, this object is further achieved with a method for delivering targeted data to a wireless transceiver forming part of a wireless communications network comprising the steps of:

obtaining information regarding the location positioning of said wireless transceiver;

creating an anonymous profile comprising information related to said wireless transceiver;

matching a group comprising at least one anonymous profile with said targeted data; and

delivering said targeted data to said wireless transceiver corresponding to said group.

In accordance with yet another aspect of the invention, this object is achieved with a system for delivering targeted data to wireless transceivers forming a wireless network, each said wireless transceiver comprising a unique identifier, said system comprising:

at least one Mediation Server for interfacing with said wireless network, said Mediation Server being adapted to create an anonymous identifier corresponding to each said unique identifier of each said wireless transceiver; and

at least one Profiling Server for interfacing with said Mediation Server and storing information corresponding to each of said anonymous identifier, said Profiling Server containing none of said unique identifiers corresponding to said wireless transceivers.

In accordance with an aspect of the present invention, the targeted data is delivered to selected groups or individual wireless users via packet or circuit switched wireless networks and wireless communications devices that include SMS and/or WAP enabled wireless transceivers.

According to an aspect of the invention, a method of providing user privacy in the context of user tracking and profiling is provided and is based on the electronic separation of data access rights related to the profiling and data encryption functions.

In accordance with an aspect of the present invention, the method for providing user privacy requires Privacy Firewalls that do not allow the merging of user profiling data with user personal identifiers, such as: user phone number; user address, user name and the like.

In accordance with another aspect of the present invention, the privacy method requires at least two parties to operate the solution, where one party controls the user personal data encryption procedures and another party analyzes the anonymized user data to infer psychographic and demographic profiles of wireless users.

In accordance with an aspect of the present invention, the encryption of user identities takes place in Mediation Servers and the analysis of the anonymized location information is performed in Profiling Servers. Mediation Servers substitute user identifiers with anonymous identifiers that conceal user identity, in order to prevent Profiling Servers to restore user identities from the anonymous identifiers. The translation of user identities into anonymous identifiers is controlled by Mediation Servers. Mediation Servers prohibit any access to encryption sensitive information (i.e. encryption keys, procedures and data) from any external network node that includes Profiling Servers by establishing Privacy Firewalls. Privacy Firewalls are a combination of software and hardware that prevent network access to the encryption keys stored on the Mediation Servers. Additionally, Privacy Firewalls provide bi-directional access that block capabilities to attempt access to the user profile information that is stored in Profiling Servers. This is preferably done by defining communication links that are connected between Mediation Servers and Profiling Servers that allow passing information to be eligible for application purposes and filter out user profile requests.

In accordance with another aspect of the present invention, the anonymous identifier may be generated from unique identifiers such as MIN, IMSI, MSISDN, MSNB, MDN or a combination of one or more than one specific identifiers on Mediation Servers. The anonymous identifier is preferably generated using the destination address of Profiling Servers. The anonymous identifier features some or all of the following characteristics: consistency (the same anonymous identifier is presented to the same Mediation Servers); uniqueness (the probability that two users are given the same anonymous identifier is low); and privacy (the recipient at the Mediation Servers cannot determine the identity of an anonymous identifier's source name).

In accordance with a further aspect of the present invention, the system takes the form of a clustered network that enables the delivery of targeted data to wireless transceivers. The system includes a plurality of network clusters that consists of Mediation Servers and Profiling Servers. Mediation Servers function as a conduit communicating information between wireless users and Profiling Servers. Profiling servers act as a collector of anonymous user profiling information that is inferred from the data that is collected by Mediation Servers.

In accordance with another aspect of the present invention, a system for the delivery of targeted data to wireless users includes some or all of the following components: a database that receives and stores anonymous user location positioning and time data that is continuously or periodically updated; a profiling module that obtains or generates identification numbers of a class or group of wireless users that is based on preset targeting; a Mediation Server that interfaces with wireless communication network devices that carry out the delivery of the targeted data to wireless transceivers, receive user location positioning data, and protect the privacy of wireless users.

The system preferably includes a database for the storing of location positioning data that relates to wireless users such as the current location positioning in unified geographic coordinates and time of registration in the geographical location. The user location parameters are identified in a database by anonymous identifiers that correspond to unique identification numbers that represent the identity of wireless users. The anonymous identification must not allow the determination of the identity of the wireless users.

In accordance with an aspect of the present invention, a method for the delivery of targeted data to wireless users in a wireless system include some or all of the following characteristics: storing data that indicates the targeted data that is associated with descriptive attributes of the targeting group of wireless users and a list of targeting attributes that is associated with the descriptive attributes of targeted data for automatic profiling of the database that contains the historical location positioning data of wireless users.

The present invention uses location positioning to determine the profile of a wireless user, and in particular the behavioral, habitual, or psychographic profile in terms of wireless user's interests, habits and preferences suggested by a user's location positioning pattern. To accomplish this, the present invention provides (i) a tracking and profiling database for recording user location positioning with respect to location and time received from the wireless network; (ii) a target profile database containing profiles of targeting groups; (iii) a management processor handling selection of targeting users. Over time, the tracking and profiling database holds a history and/or pattern which in turn is interpreted as a user's habits and/or preferences through correlation of the location positioning patterns and properties of the locations visited. In that respect, a behavioral or habitual profile is deduced from this “location tracking” and is recorded in the profiling database.

In accordance with another aspect of the present invention, a method for selecting targeted group of wireless users is provided and includes triggers consisting of location positioning, time, and profile triggers.

### BRIEF DESCRIPTION OF THE DRAWINGS

The present invention and its advantages will be more easily understood after reading the following description of preferred embodiments thereof, made with reference to the following drawings in which:

FIG. 1 is a schematic representation of two-way exchanges between a targeted data provider and wireless operators using the system of the present invention;

FIG. 2 illustrates a high-level block diagram of an exemplary distributed network with which the principles of the present invention may be suitably used to provide a central Mediation Server for coordinating location positioning profile data exchange between individual Profiling Servers;

FIG. 3 is a diagram of a wireless communications network implementing a location sensitive advertising platform in accordance with the present invention;

FIG. 4 is a top-level component diagram of the Mediation Server;

FIG. 5 is a top-level component diagram of the Profiling Server;

FIG. 6 is a flow-chart illustrating system operation in the mode of tracking and user location;

FIG. 7 is a flow-chart illustrating the system process of launching and executing a location sensitive targeted data delivery campaign; and

FIG. 8 illustrates a high-level block diagram of an exemplary distributed network implementing location sensitive advertising network in accordance with an alternative implementation of the invention.

### DESCRIPTION OF PREFERRED EMBODIMENTS OF THE INVENTION

The present invention is a network communications system for the delivery of targeted data to wireless transceivers of wireless users in a wireless communications network. The system offers a high precision of selecting a targeted class or group of wireless users through the tracking and profiling of a user's location positioning data collected from wireless networks. The system collects and stores wireless user location positioning data in a non-personally identifiable format to protect the privacy of wireless users. The system establishes a user privacy management framework that enables differentiated access to the user related information including user personal identifiers and user profile information inferred from continuous tracking of user location. The system does not require a user request to deliver targeted data to the user's wireless transceiver and accumulates information and data without necessitating any user intervention. The system continually compares properties of the targeted data with the current profile of the wireless user “pushing” content when there is a match between the two. The system performs continuous comparison based on a number of parameters including user location, user behavioral profile, time and location related events.

In accordance with the present invention, a wireless transceiver may feature some or all of the following characteristics: personal to a single user, portable, location specific and time sensitive. Location specific is understood to mean that the physical location of a user carrying the wireless transceiver may be ascertained. Time sensitive is understood to mean the physical location of the person carrying the wireless transceiver may be situated in time or may be known at a point in time. The present descriptions also interchangeably uses the expressions “wireless transceiver location” and “user location”, given the fact that the present invention makes use of certain information related to a given wireless transceiver in order to infer information related to a user.

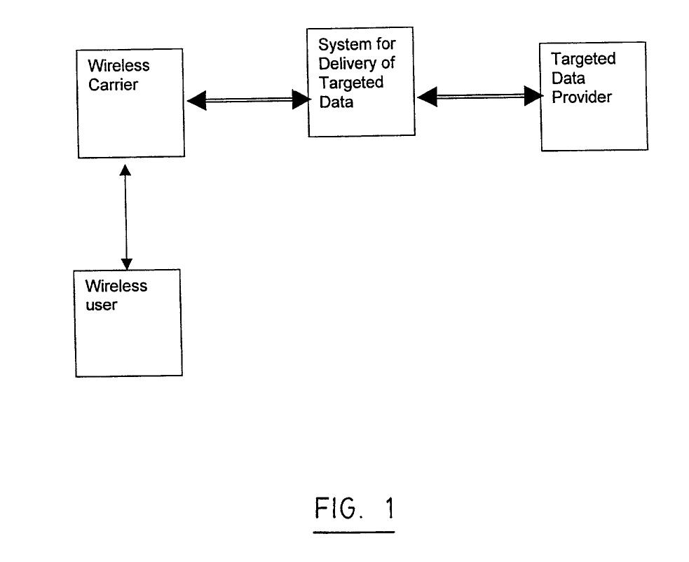

As illustrated in FIG. 1, the system of the present invention can be used to facilitate a two-way exchange of information between wireless users and targeted data providers (e.g., advertisers) with the purpose to enable access of the sponsors to the targeted wireless users.

It should be understood that the term “user” means wireless user in the context of the present invention, and is meant to include a person having a wireless transceiver, as defined above. Furthermore, the expression “targeted data provider” is meant to include an advertiser, a content provider, or any other person wishing to target information to a class or group of users.

To facilitate a complete understanding of the invention, the remainder of the detailed description is arranged in the following sections and subsections:

I. Glossary of Terms and Acronyms

II. Overview of the Preferred System

III. Implementation of the Preferred System

A. Profiling Server

B. Mediation Server

C. Network Architecture

IV. Method for Encryption of User Identities

V. Method for Behavioral Profiling

VI. Method for Profile Exchange

VI. System Operation

I. Glossary of Terms and Acronyms

CDR Call Detail Record

CGI Global Cell Identity

EDR Event Detail Records

ESN Electronic Ser. Number

MIN Mobile Identification Number

MSISDN Mobile Wireless user ISDN (Integrated Services Digital Network) number

MDN Mobile Directory Number

MSNB Mobile Ser. Number

IMSI International Mobile Station Identity

IP Internet Protocol

TCP Transmission Control Protocol

GPS Global Positioning System

WAP Wireless Application Protocol

II. Overview

This section provides an overview of a communication system according to a preferred embodiment of the present invention. As mentioned previously, the present invention enables implementation of location sensitive profiling and delivery of targeted data in a wireless telecommunications network. However, it will be appreciated that certain aspects of the present invention are more broadly applicable to other location-based services. Example of such services would be content “push” applications delivering content message and alerts to the wireless users. Another example is demographic and psychographic research applications in the context of marketing studies implementing services through profiling of user location positioning. The latter do not necessitate delivery of the content message to the wireless users, but are nonetheless covered by the scope of the present invention. In addition, although certain characteristics of the invention will be described in relation to IS-41 and IS-124 compatible telecommunications networks, it will be appreciated that the present invention is not limited to such implementations.

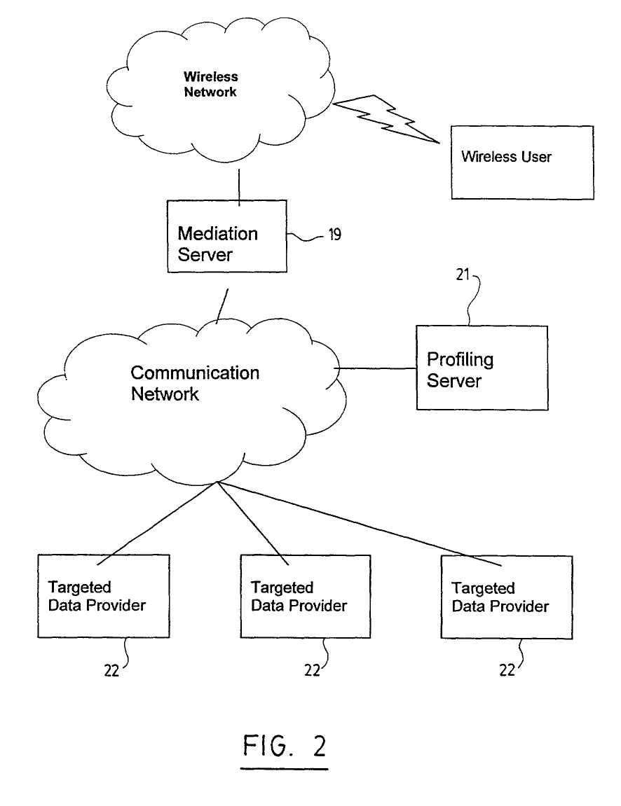

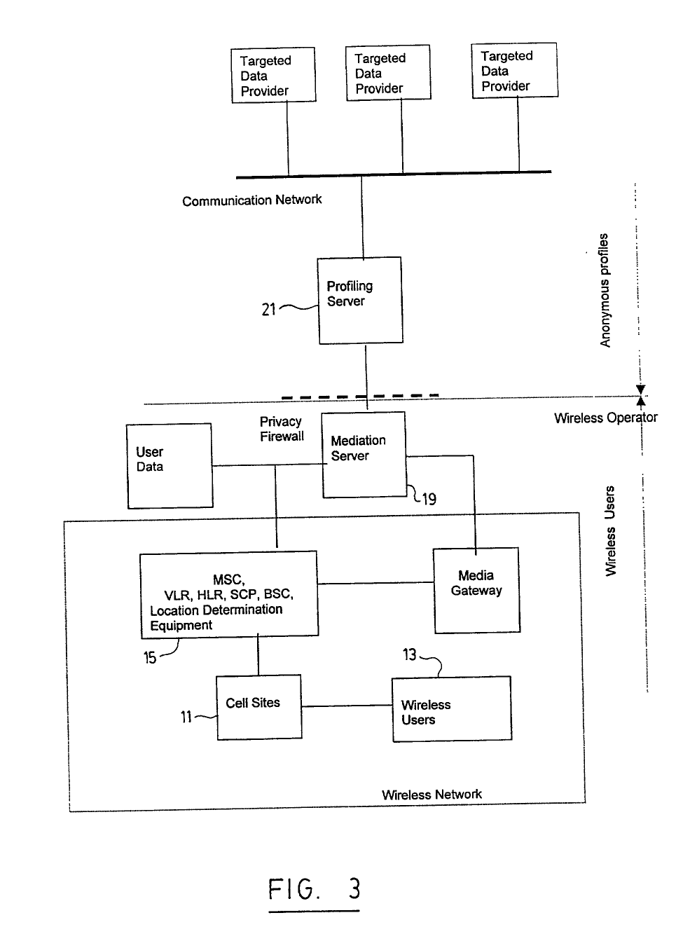

Referring to FIGS. 2 and 3 there is shown a high-level block diagram of the basic architecture of the location-based data profiling system according to a preferred embodiment of the invention implemented on a wireless network. Although not shown, the wireless network is composed of a number of service areas or cells, depending on the architecture of the network.

Each cell or service area of a wireless network includes site equipment 11 for receiving RF signals from wireless transceivers of users and transmitting RF signals to the wireless transceivers 13. The site equipment of multiple sites are, in turn, connected to a Mobile Switching Center (MSC) 15, typically by a wireline connection. Among other things, the MSC is used in establishing voice channels for communication between the calling and called wireless transceivers. The MSC also provides information for generating call detail records (CDR) or other billing records including event detail records (EDR).

To establish communication between calling and called wireless users, the MSC, among other things, performs continuous tracking of user location in the wireless network. This is achieved though the process of registration of wireless transceivers on the wireless network. The registration procedure requires active wireless transceivers to report their location in the wireless network, indicating their current whereabouts. The site is identified by the global cell identity (CGI) for a wireless communications network or by any other unique location identifier. There are different types of registrations in the wireless network including periodic, forced, power-up and power-down registration. It should be noted that even though cell-tracking property of the wireless network is used in the current implementation of the invention, it is not required for the invention in general.

A wireless network can be configured outputs billing information in the format compliant with IS-124 standard, which, among other things, may output registration and call detail information shortly after the event occurred in the network. This protocol enables passive tracking of user locations, not requiring individual requests for mobile positioning. This protocol is used in the current invention for illustration purposes only, assuming that broader interpretation of user location tracking via alternative means can be achieved.

In connection with the MSC, one or more platforms can be used to track location of wireless users collectively defined in FIG. 3 as Mobile Location Gateways (MLG) 17. MLG can track location of end users based on ANSI 124 standard implementation transmitting location identified network events to the Mediation Server. Also, MLG can determine the location of wireless transceivers based on inputs from different location determination technologies based on the analysis of signals transmitted between the telephone system and one or more sites, e.g., cell/sector, micro/pico cells, AOA, TOA, etc. The MLG may also include location inputs from GPS devices. The Mediation Server receives information from one or more positioning data streams and implements the logic of capturing the most recent location of each wireless user. The tracking of user location can be performed via MLG using push or pull type of interfaces. The implementation based on ANSI 124 refers to passive tracking and is based on the push-type of interface.

In connection with the MSC 15, other components of the wireless network are provided including Home Location Register, Visitor Location Register and optionally IN components such as Service Control Points and Switching Control Points. Each of these components may be used to enable tracking of user location in the wireless network based on IS-41 related protocols and proprietary protocols enabling access to the network components. Generally, any interface to a Visitor Location Register and/or Mobile Switching Center can be used to enable Mediation Server to receive wireless network events indicating location of users in wireless network.

The Mediation Server 19 interfaces with the wireless network to receive network events associated with wireless transceivers and comprising unique identifiers including location information, time, network event tags, and the like. An example of network events includes periodic registrations, hand-off events, call detail records, and the like. Alternatively, the network events can be retrieved from Visitor Location Register through any of the data interfaces to the VLR.

The Mediation Server receives network events through interfaces to the wireless network without requesting any actions from wireless users as to their wireless transceivers. The passive collection of user related network events refers to gathering network information generated as result of radio communications between wireless transceivers and the wireless network. In addition, network events may include events generated by user phone activities including dialing numbers, placing a call, establishing wireless Internet connection, and the like.

The system further includes a Mediation Server 19 mentioned above and a Profiling Server 21 communicating with each other by use of a remote link via an established data communication protocol. This pair of servers features differentiated data access right capabilities requiring that the party that operates the Profiling Server 21 does not give access right privileges to the party operating Mediation Server 19 specifically for the data related to user profiles. Conversely, the party operating Mediation Server 19 is restricted from giving data access rights to the party dealing with user profiles including the party that operates the Profiling Server 21. This insures anonymity of the location data to the parties that use location information for one of the following purposes, including inferring psychographic information about users, “pushing” targeted data to wireless transceivers, and the like.

The scheme of differentiated data access rights can be implemented through a variety of technological solutions including electronic separation of the data structures, partitioning databases with differentiated access right privileges or the like.

The solution, according to a preferred embodiment of the present invention, consists of the network separation of user profile information from user personal information by placing profiles on the Profiling Server and personal information on the Mediation Server. Next, the procedure requires that the encryption of user identities be performed on the Mediation Server. The encryption includes: storage of encryption keys, look-up tables for identifier conversion, and encryption methods. Next, the procedure requires restrictions on the electronic protocols for data exchange between the Mediation Servers 19 and Profiling Servers 21. Profiling servers are prohibited from sending out any information that is related to the encrypting methods, including: keys and conversion methods; and Profiling Servers 21 are prohibited from sending out any information that is related to user profiles.

The Profiling Server 21 enables the creation of user behavioral and psychographic profiles by providing access to some or all of the following information: the historical wireless user location positioning data, profiling location positioning patterns, compiling user profile databases and selecting targeted profiles that correspond to defined profile selection criteria. The Profiling Server 21 encompasses functions that converts user location positioning that is accumulated for example, over a long period of time, into psychographic and demographic user profiles that may be represented in the format of a list of categorical attributes, an example of which will be shown hereinafter.

User profile information can be retrieved through various sources including user polls and questionnaires, regional population demographics data, and any other source of user profile information. All these sources are denoted as User Data in the FIG. 3. The following illustrates scenarios of obtaining user profile data.

A wireless user may be offered to fill out a user profile. The user profile may be filled out in hard copy or as an alternative, the user may fill out the user profile from handset menus or Internet based application or the like. The user profile may contain answers to the questions including, age, sex, interests, hobbies and the like. The profile is forwarded to the Profiling Server 21 through the Mediation Server 19, which removes user personal identifiers.

User profile information may be inferred through the analysis of user location positioning using heuristic methods that validate assumptions about user habits against user location positioning patterns. An example of this analysis would be a profile category of a “frequent golfer” if the user location positioning patterns suggest frequent visits to golf courses on weekends.

The Mediation Server 19 enables real-time collection of wireless user location positioning data from wireless network, encryption of user personal identifiers that generates location records in anonymized format and distribution of anonymized location records for storage, tracking and profiling purposes.

The Mediation Server analyzes network event information to generate location detail records comprising anonymous identifier and location positioning data. The location detail records may be generated for each packet of network information received from the wireless network. The record may also include other information about network events such as the time stamp of the received event, network event tag, network system identifiers, and other network information.

The basic operation of the system can be described as follows: conceptually the system may operate in two modes such as a collection mode and a “push” mode. The “push” mode of operation is associated with system functionalities enabling the broadcast of targeted data to selected wireless transceivers. The transceivers are anonymously selected through the comparison of anonymous profiles with event triggers associated with the targeted data. The event triggers include location positioning data, time frames and desired profile of the targeted users. The anonymous profiles contains user profile attributes, last know location information, time stamp, network event identifier and the like.

The collection mode of operation may be associated with the continuous passive gathering of user location positioning that originates from a wireless network.

The system operation in the “push” mode may be illustrated by the example of a content provider that may wish to deliver personalized, relevant, location specific and time sensitive content or data to a class or group of wireless users based on certain profiling characteristics. The Profiling Server 21 translates the description of the targeted group into a set of targeted parameters that defines the preferred attributes and triggers the delivery of content or data.

Next, in the active mode the system associates targeted criteria of the content provider with dynamically updated profiles of wireless users to identify the profiles that correspond to the class or group of targeted users. The system associates the content with a corresponding array of profile identification numbers. As a next step, Mediation Servers translate anonymous profile identifiers into the mobile identification numbers (MIN) or any similar wireless transceiver identifier for the delivery of targeted data to wireless transceivers that belongs to the targeted wireless users. The system delivers content to wireless users in accordance with transmission and presentation preferences that may be selected by the content provider.

III. Implementation

The system implementation scenario described in the following sections may be used for illustration purposes only and may not be used to limit the scope of the appended claims. The designation of some of the functional components of the system relating the profiling and Mediation Servers may be arbitrary and may depend on the specific design of a particular system. Some of the functional components may have fixed designations.

In a particular embodiment, Profiling Servers may have components that may provision user profile management functions such as profile creation, storage and retrieval. Mediation Servers may include some or all of the following features: the collection of user data that may be identified by mobile identification numbers, and the encryption and distribution of anonymized user data for profiling and tracking operations.

In a particular embodiment, the notion of profiling and Mediation Servers may be interpreted in a broad sense to mean that each server can be considered a network node consisting of many servers.

A. The Profiling Server

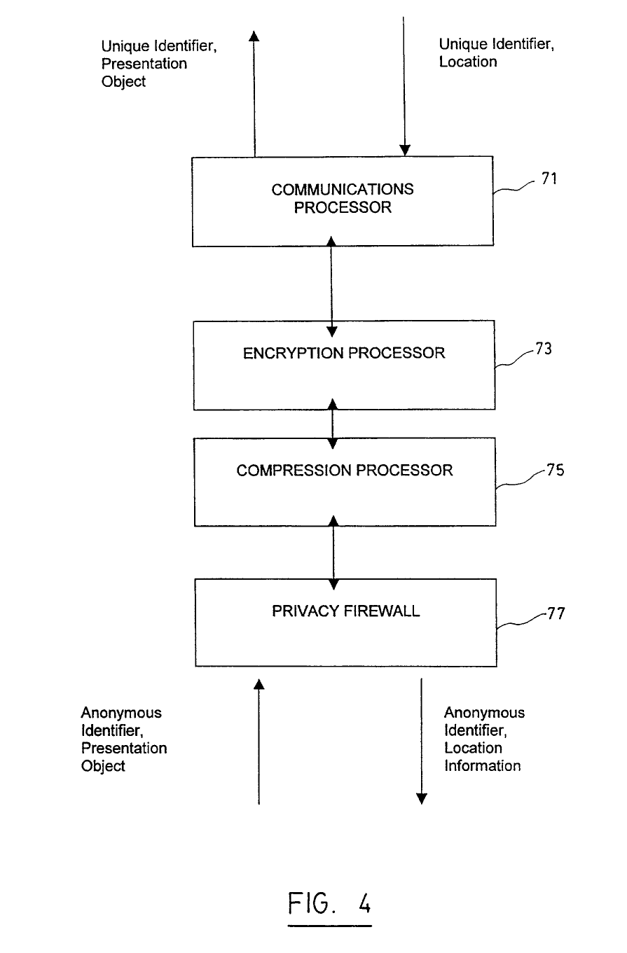

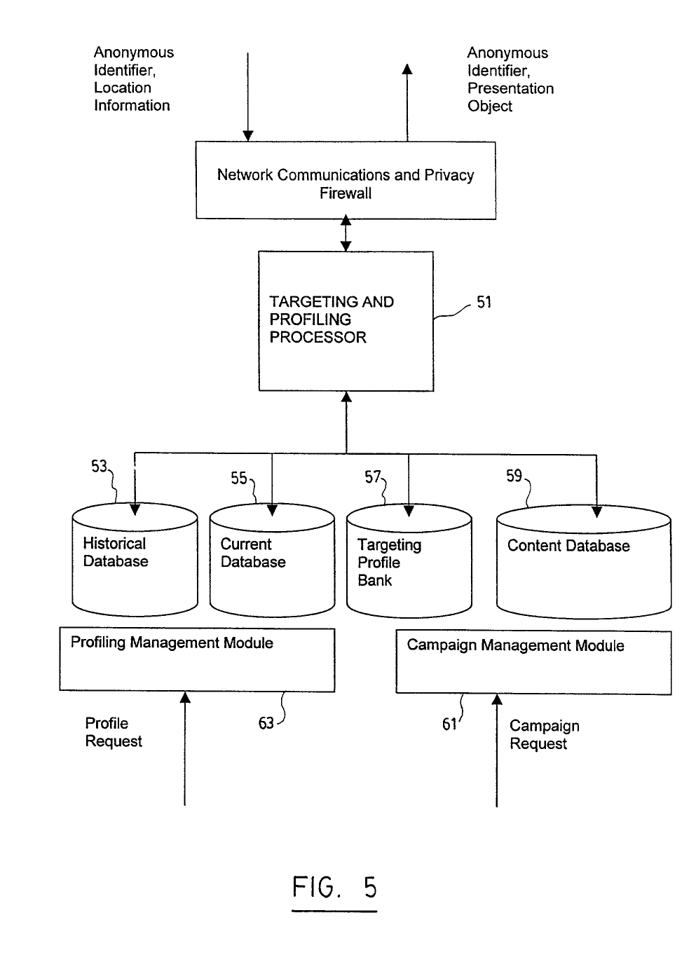

FIGS. 4 and 5 illustrate the top-level logical component structure of the Profiling Server 21 according to a preferred embodiment of the present invention (FIG. 5 is the continuation of FIG. 4). In a preferred embodiment, the Profiling Server 21 includes a targeting processor, a profiling processor that may be integrated in box 51, a profile management module and a campaign management module. Each of the component parts shown in FIGS. 4 and 5 are described below.

The collection of database modules includes: a Historical Database (HDB) 53, a Target Profile Bank (TPB) 57, a Content Database (CDB) 59, and a Current Database (CDB) 55. The databases are introduced to collect and store location positioning along with other wireless network related data to enable psychographic profiling and “push” interface capabilities.

The CDB 55 receives and stores the most recent location data transmitted from the Mediation Server 21 as a sequence of records that indicate user location. The structure of the location data stored in the CDB 55 includes some or all of the following elements: the profile identification number; the geographical coordinates expressed in latitude and longitude; the time stamp; the network trigger; and the calling area code. The CDB 55 provides a snapshot view of user geographical distribution and feeds data into the HDB 53 to make location data available for profiling. The network trigger defines the type of network event that has generated the location record in the wireless network. An example of a network trigger may be power-on registration, periodic registration, location update request and the like.

The CDB 59 contains presentation objects along with associated targeting criteria. The data structure of each of the targeting objects may include some or all of the following elements: data objects; category identifiers; targeting conditions; and presentation conditions. The targeting criteria are constructed through manual association of data objects with targeting profile criteria for the object and other data regarding presentation of the object. The profile construction is facilitated by the Campaign Management Module (CMM) 61 that provides an interactive software environment for the specification of profiling properties for each targeting profile including the setting of triggers.

The Targeting Profile Bank (TPB) 57 is created through the association of profile identification numbers with categories representing psychographic and demographic properties of wireless users. An example of such categories would be age category, gender, place of residence, place of work, consumer habits, personal interests, and the like. The Profile Management Module (PMM) 63 enables a data provider to create a custom set of categories by associating results of profiling requests with custom created profile categories. Custom profile categories constitute a list of attributes that may be inferred from user historical location positioning data. An example of custom categories includes frequent visitors to a sports facility, frequent users of an airport, or frequent visitors of a shopping district.

The Historical Database (HDB) 53 receives, stores and maintains location positioning profile information for each of the profile identification numbers. The HDB 53 continuously receives location positioning records from the Mediation Server 19, than later storing essential positioning parameters such as location, time, network event, and a time-step parameter. The time-step parameter indicates the speed of changes to the location positioning patterns. The HDB 53 responds to queries from the Profile Management Module (PMM) 63 to identify each of the anonymous identifiers that are deemed to have the location positioning pattern matching the one specified in the queries.

The Campaign Management Module (CMM) 61 defines, stores and manages campaign order information and campaign specification parameters.

The CMM 61 enables a data provider to define the campaign, associating the targeting information object with a targeting command, containing (i) attributes of the targeted group of profiles and (ii) parameters of the object presentation to the profiles. The CMM 61 primarily functions to map description of the marketing message specified by a targeted data provider into the targeting criteria of the targeting information object indicating conditions for targeted profiles selection. The CMM contains functionality to aid translation of targeted object descriptions into longitude and latitude coordinates of the targeted object.

The PMM 63 enables data providers to create custom profiles of users that may be based on inferences made from the analysis of the historical location positioning data. For efficient profiling of user location positioning historical data, the PMM 63 may perform profiling off-line, may respond to a command from a targeted data provider that identifies some or all profiles in the HDB that match the time and location conditions of the targeting command. For example, for a targeting category defining frequent visitors to a ski area, the PMM may initiate scanning of the HDB that may select each profile that has been registered in the targeting location of a ski area any given number of times.

The CMM 61 contains the functionality to enable exchange of profile data between communicating Profiling Servers. The CMM of a Profiling Server forwards a request over a public network to a central Profiling Server that retrieves a user profile with specified attributes. The CMM receives and stores requested profiles in a corresponding profile data storage.

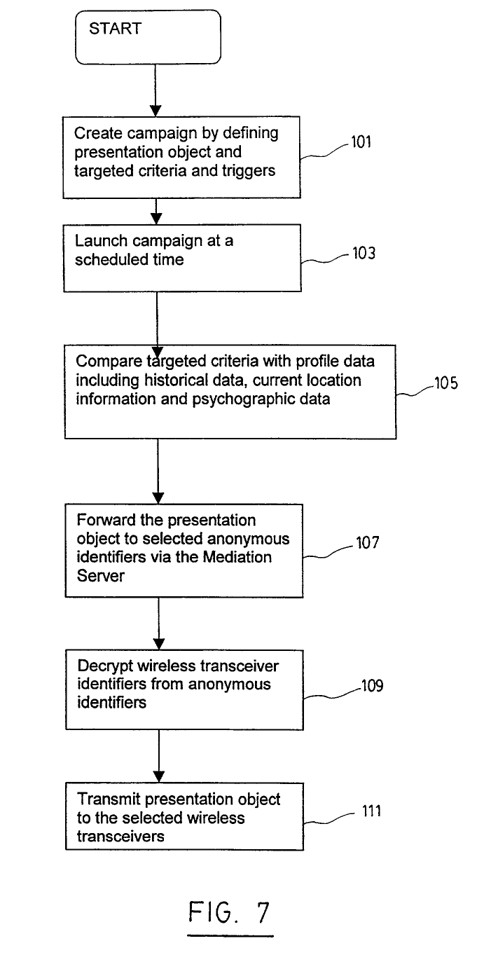

The Targeting and Profiling Processor (TPP) 51, responding to a campaign order that is received from the CDB 59, selects targeting profiles by matching targeting criteria with parameters of the profiles. The process of targeting is shown in detail in FIG. 7. First, the data provider defines a campaign order including message content and targeting criteria 101. The message content may be in the format of a text message for SMS or WAP presentation channels, audio, video or the like. Once the campaign is scheduled for presentation 103, the targeting criteria associated with the campaign are forwarded to the TPP 51 for the tracking of triggering conditions. The TPP 51 performs the continuous comparison of incoming anonymous identifiers with the targeting criteria for the campaign that is based on profile, location and event triggering parameters of the targeting criteria. Once matching conditions are identified 105, the TPP 51 forwards the data along with selected anonymous identifiers to the Mediation Server for delivery to the corresponding wireless transceivers 107. The unique identifiers of the targeted mobile units is decrypted from the anonymous identifiers 109 and the delivery of the object to the wireless transceiver is performed 111.

The TPP 51 also creates psychographic and demographic user profiles by associating targeting criteria with anonymous identifiers through comparison of targeting criteria for each of the categories with the historical location positioning data. The TPP 51 responds to profile orders received from the PMM 63. The profile order includes a list of profiling parameters and predefined category ID for those parameters. For example, the order may contain the name of a category called frequent visitors to a ski area, the location coordinates of the ski area, the time of visiting the ski area, the duration of stay in the ski area, and the number of visits to the ski area. Upon receipt of the profile order, the TPP 51 scans the HDB records for anonymous identifiers with location parameters that match the targeting criteria specified in the profile order. Upon completion of the search, the TPP updates the TPB 57 by adding the new profile category to each of the selected anonymous identifiers.

B. The Mediation Server

FIG. 4 illustrates the main components of the Mediation Server 19 according to a preferred embodiment of the present invention. As will be described in detail below, the Mediation Server includes a Communications Processor (CP) 71, an Encryption Processor (EP) 73, a Compression Processor 75, and a Privacy Firewall (PF) 77.

The Communications Processor (CP) 71 performs interfacing functions with devices in the wireless network that supply user location data to the Mediation Server 19. An example of the CP 71 is a module communicating with a source of IS-124 formatted data records originating from the MSC. It should be noted that other modules may perform this same function. The CP 71 is designed to interface with a multiplicity of location data sources residing in the wireless network. The CP 71 outputs data records that include the user identification number, the user location, the time stamp, and the record type. The CP 71 collects information from various sources of the location positioning data, including the billing records (CDRs and EDRs), the DMH records, the mobile positioning data (MPS), and the global positioning data (GPS). The CP 71 supports both push and pull type interfaces. Primary location positioning records are identified by unique identifiers of wireless transceivers, including the mobile identification number (MIN), the international mobile system identity (IMSI), and the MSISDN amongst others.

The CP 71 also translates incoming data containing location positioning into a sequence of structured location detail records (LDR) that contains location parameters, including geographical coordinates, the time of registration in the geographical location, and the duration of stay in the given location. The LDR may also include network event tags and other network related information. The LDR represents a standardized format of location records that are used throughout the system of the present invention. To produce a location record in LDR format, primary location information is converted into a standardized format including the latitude and longitude of user location. User location in the incoming records are represented in a variety of ways, such as alphanumeric names that represent CGI, and X and Y coordinates of the user location.

The Compression Processor 75 filters out positioning records representing stationary user positions, such that if a user does not change location, the Mediation Server does not send the updated location record, which is advantageous to reduce transmission data rates.

The Encryption Module (EP) 73 substitutes or encode the Mobile Identification Number (MIN) and/or other unique identifiers, including IMSI, MSISDN or Mobile IP, with an anonymous identifier that prevents the identification of wireless users in the location positioning data records outside the Mediation Server. The EP 73 translates or decodes the user anonymous identifiers into MINs or any other appropriate mobile identifier, to direct messages that are be generated by the Profiling Server 21 to the wireless users.

The Privacy Firewall 77 is a network filter that filters out any requests from outside of the Mediation Server originating from the Profiling Server, or any other unauthorized entity to access data that may be associated with the encryption module, including encryption keys and translation tables of MINs into anonymous identifiers. The PF 77 enables communication between the Mediation Server and the Profiling Server, but limits the scope of the communications protocol to the transmission of LDRs to the Profiling Server and anonymous identifier identified targeting messages from the Profiling Server. The PF ensures that the owners of user profiles may not have access to the encryption keys that may potentially allow reverse translation of anonymous identifiers into wireless user identifiers.

C. Network Architecture

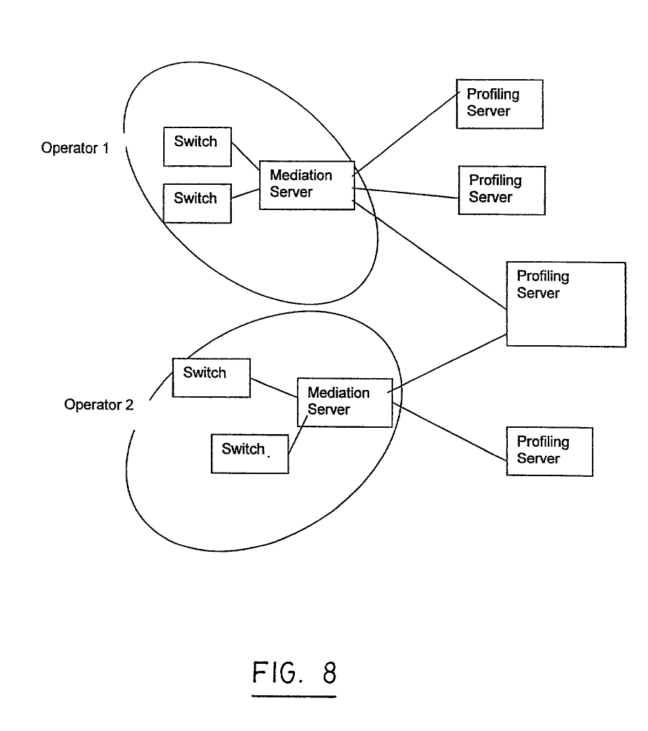

Illustrated in FIG. 8 is a high-level block diagram of an exemplary network, which contains a plurality of Profiling Servers 21, plurality of Mediation Servers (although only one is shown in FIG. 2). Each of the Mediation Servers interconnects with the wireless network to receive location positioning data from the wireless network and sending targeted data to wireless users. Each of the Profiling Servers 21 provides an interactive environment for targeted data delivery and profiling user location positioning data.

The Mediation Servers preferably reside at the premises of the network operator as adjunct processors to the wireless network equipment. Positioning of Mediation Servers at the wireless network carrier premises qualifies Mediation Servers to handle security matters on behalf of the wireless users. The Profiling Server is accessed by one ore more targeted data providers via a remote link or public network and can be positioned in any geographical location.

The network architecture of the present invention coupled with the security procedure outlined below enables unique, secure and interoperable addressing of the wireless users.

A wide range of untrustworthy communication mediums can be employed for the purposes of the present invention to connect the profiling and Mediation Servers together, including the Internet (or any other public network), a private network, a private communication channel, or a combination thereof.

IV. Security of User Identities

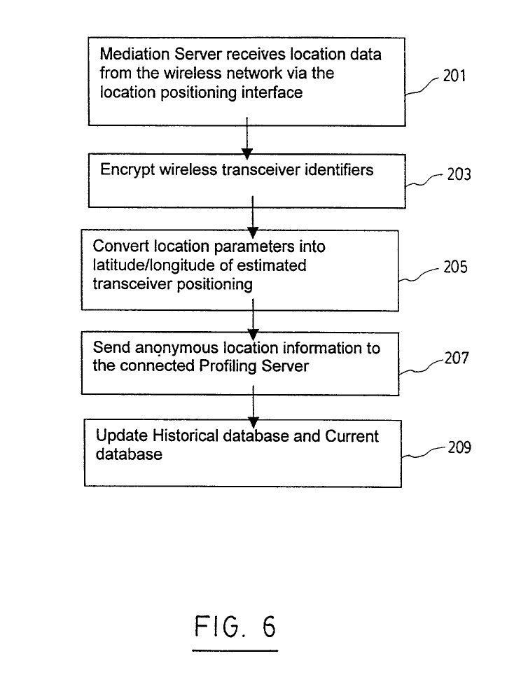

One of the aspects of the present invention is that a user may be anonymously profiled using the location of the user within a wireless network. The present invention also provides a method for concealing personal identifiers of wireless user, shown in FIG. 6. The method essentially consists of two components. The first component requires the substitution of the unique identifiers of the wireless transceivers with an anonymous identifier. The second component requires network separation of the Profiling Servers and Mediation Servers along differentiated access to the encryption and profiling information.

The method provides for the translation of personal identities of wireless users into an anonymous identifier, which prevents the Profiling Servers 21 from recognizing the true identity of wireless users when using those anonymous identifiers for unique identification of wireless users. The encryption method is preferably a software program encapsulated in the Encryption Processor 73 of the Mediation Server 19. The method may advantageously allow Profiling Servers 21 of the advertising network to gather location positioning for wireless users, that may carry out profiling of the collected location positioning data and target advertising messages using no personal identities of wireless users. The operation of the encryption method may allow Profiling Servers to exchange user profiles that may be indexed by Profiling Server-specific anonymous identifiers that may not have to share secret decoding keys.

The anonymous identifier are preferably generated at the Mediation Server 21 by combining the MIN with a pseudo-random number (PSI) that is be assigned by the Mediation Server to each of connected Profiling Servers (e.g., by interleaving the bits of MIN with the bits of PSI), and then using a conventional one-way (e.g., nonreversible) hash algorithm such as Message-Digest 5 (MD5) to convert the anonymous identifier/PSI combination into a hash code. This technique is well known in the art. Because the anonymous identifier is preferably generated using a one-way hash algorithm, the operator of a Profiling Server cannot extract user MINs or any other useful information about the identity of wireless users from the anonymous identifier code. The one-way hash algorithm is used here as an example; however, the present invention may contemplate the use of any other type of cryptographic algorithms that generates anonymous identifier codes.

The method according to a preferred embodiment of the present invention preferably generates a server-specific set of anonymous identifiers that is be unique for each of the network clusters. If the MD5 method is applied, the Mediation Server 19 may be required to maintain a look-up table for reverse translation of profile identification numbers into MINs.

The privacy method preferably contemplates differentiated access rights to the information stored in Mediation 19 and Profiling Servers 21. Outbound communication from the Mediation Server 19 is limited to the transmission of Location Detail Records that are identified by anonymous identifier codes. The protocol for the inbound communication is thus limited to the transmission to the Mediation Server 19 of presentation objects that are be identified by anonymous identifier codes. The Mediation Server 19 includes software and hardware components providing for the user privacy solution. The Privacy Firewall of the Mediation Server is preferably adapted to block access to this information to unauthorized parties, including the parties that operate Profiling Servers, in order to maintain a high level of integrity of the system.

The Profiling Server 21 responds to profiling request from marketers via the Profiling Management Interface 63 and returns aggregated statistical view of profiles without displaying associated anonymous identifier codes. A profiling query to identify all wireless users located in a ski area may return a number that may represent a total of matching profiles.

Referring to FIG. 6, the location positioning data is received by the Mediation Server, through a billing, GPS, MPS, or any other signaling interface at 201. The Mediation Server, as mentioned previously, encrypts the user information in the location data records 203. The location parameters are converted into, for example, latitude/longitude of the user location 205. The anonymized location detail records may be sent to the Profiling Server 21 at 207 and the Historical and Current Position Databases 53 and 55 are updated 209.

V. System Operation

The operation of the system will be described in connection with the flow charts shown in FIGS. 6 and 7 illustrating the process flow of a system for the delivering and targeting of data in accordance with a preferred embodiment of the present invention.

Targeting Process

Referring to FIG. 7, the targeting process is initiated by a data provider that may determine some or all of the following parameters: the kind of data; the class or group of wireless users; the targeting criteria, including location, time, event and/or historical behavior; and the delivery specifications, including frequency, time, maximum number, and the like.

Referring to block 101, the data provider establishes targeting parameters that may be associated with the specifics of the data to be delivered. The composed campaign order is stored in the Content Database 59.

Referring to block 103, the system identifies the data scheduled for delivery and inserts the parameters into the Targeting and Profiling Processor (TPP) 51.

The TPP 51 continuously compares targeting criteria of the campaign with the run time parameters for each of the anonymous identifiers at 105. The TPP 51 identifies each of the anonymous identifiers at a given point in time with conditions that match the ones that may be specified for the marketing campaign. For each of the selected anonymous identifiers, the system verifies the parameters of the message presentation, including the number of presentations and the specifics of the targeting wireless transceivers to deliver data according to the data presentation criterion.

With reference to block 107, the Profiling Server 21 forwards the data for each for the selected anonymous identifiers to the connected Mediation Server 19.

With reference to block 109, the Mediation Server 19, upon receipt of the content message with a list of targeted anonymous identifiers, performs the conversion of anonymous identifiers into MINs.

With reference to block 111, after decrypting user identities, the Mediation Server sends data to each of the selected users for delivery to the wireless transceivers.

The present invention provides for a method and system for profiling users that is based on the location of wireless users, and on the fact that the particular user may not be identified, i.e. the system and method of the present invention are anonymous.

Although the present invention has been explained herein above by way of a preferred embodiment thereof, it should be pointed out that any modifications to this preferred embodiment within the scope of the appended claims shall not be deemed to alter or change the nature and scope of the present invention.

1. In a wireless communications network, said network comprising a plurality of wireless transceivers, each of said wireless transceivers being uniquely identified by at least one unique identifier, a method for anonymizing data from said wireless transceivers comprising the steps of:
obtaining data related to said wireless transceiver;
substituting said unique identifier with an anonymous identifier; and
creating a record of said data associated with said anonymous identifier.

2. A method according to claim 1 where said method further includes the step of associating said anonymous identifier with an anonymous profile associated with each wireless transceiver.

3. A method according to claim 2, wherein said anonymous profile includes information obtained from an external source.

4. A method according to claim 1 where said step of obtaining is performed passively.

5. A method according to claim 1 wherein said data is generated by communication between said wireless communications network and said wireless transceivers.

6. A method according to claim 1 where said method further comprises the step of analyzing received data to retrieve information related to said wireless transceiver including location positioning, time, and network events.

7. A method according to claim 6 wherein said location positioning is defined by said wireless transceiver positioning in wireless network using cell ID, or latitude/longitude of said wireless transceiver.

8. A method according to claim 6 wherein said location positioning is delivered through the wireless communications network.

9. A method according to claim 6, wherein said time comprises the time of said location positioning and network event.

10. A method according to claim 6, wherein said network event comprises network data triggered by the communications between said wireless transceivers and said wireless network.

11. A method according to claim 1, where said method further comprises analyzing received data to retrieve at least one unique identifier from a group of wireless transceiver identifiers including MIN, MDN, MSISDN, Mobile IP and ESN.

12. A method according to claim 1, wherein said step of substituting said at least one unique identifier with an anonymous identifier includes converting said at least one unique identifier into an anonymous identifier that has a low correlation with one or more of said set of wireless transceiver identifiers or a combination thereof.

13. A method according to claim 1, wherein said step of creating comprises placing said data associated with said anonymous identifier into a database.

14. A method for delivering targeted data to a wireless transceiver forming part of a wireless communications network comprising the steps of:
obtaining information regarding the location positioning of said wireless transceiver;
creating an anonymous profile comprising information related to said wireless transceiver;
matching a group comprising at least one anonymous profile with said targeted data; and
delivering said targeted data to said wireless transceiver corresponding to said group.

15. A method according to claim 14, wherein the step of delivering comprises converting anonymous identifiers of said group into corresponding unique identifiers corresponding to said wireless transceivers in said wireless network.

16. A method according to claim 14, wherein said step of creating includes generating an anonymous identifier.

17. A method according to claim 14, wherein said step of creating includes associating said anonymous identifier with location positioning of corresponding said wireless transceiver and time of said location positioning.

18. A method according to claim 17, wherein said location positioning comprises data iteratively collected from said wireless transceivers.

19. A method according to claim 14, wherein said step of creating includes associating said anonymous identifier with historical location positioning of said corresponding wireless transceiver and time of each said historical location positioning.

20. A method according to claim 14, wherein said step of creating includes associating said anonymous identifier with user habit data and user preference data.

21. A method according to claim 20, wherein said user habit data is obtained by comparing external data with one or more of said location positioning and time.

22. A method according to claim 20, wherein said user preference data is obtained through questionnaires, surveys, or inferences or a combination thereof.

23. A method according to claim 14, wherein said step of matching includes the steps of obtaining triggers associated with said data.

24. A method according to claim 23, wherein said triggers further include time.

25. A method according to claim 23 wherein said triggers further include location positioning.

26. A method according to claim 23 wherein said triggers further include profile data.

27. A method according to claim 14, wherein the step of delivery comprises making said data available to processing equipment of said wireless network.

28. A method according to claim 14, wherein the step of delivery comprises transmitting said data to said wireless transceiver.

29. A method according to claim 14, wherein the step of delivery comprises alerting said user of said wireless transceiver.

30. A system for delivering targeted data to wireless transceivers forming a wireless network, each said wireless transceiver comprising a unique identifier, said system comprising:
at least one Mediation Server for interfacing with said wireless network, said Mediation Server being adapted to create an anonymous identifier corresponding to each said unique identifier of each said wireless transceiver; and
at least one Profiling Server for interfacing with said Mediation Server and storing information corresponding to each of said anonymous identifier, said Profiling Server containing none of said unique identifiers corresponding to said wireless transceivers.

31. A system according to claim 30, wherein said Mediation Server comprises an encryption processor for providing two-way translation between unique identifiers and anonymous identifiers.

32. A system according to claim 30, wherein said Mediation Server comprises a communications processor for transmitting said targeted data to said wireless communications network for subsequent presentation of said targeted data to wireless transceivers; the communications processor receiving primary data from wireless network devices in the form of packets comprising information about location positioning of wireless transceivers; the communications processor providing estimates of a wireless transceiver positioning.

33. A system according to claim 30, wherein said Profiling Server comprises a historical database for recording location positioning of wireless transceivers including said location positioning, said time, and said network events.

34. A system according to claim 30, wherein said Profiling Server comprises a current database containing most recent location positioning of said wireless transceivers including said location positioning, said time, and said network events.

35. A system according to claim 30, wherein said Profiling Server comprises a profile database containing anonymous profiles.

36. A system according to claim 30, wherein said Profiling Server comprises a profiling processor to pass anonymous identifiers and said targeted data associated to said anonymous identifiers to said Mediation Server.

37. A system according to claim 36, wherein said profiling processor comprises a temporal filter to filter said anonymous identifiers based on a set of time constraints.

38. A system according to claim 36, wherein said profiling processor comprises a location filter for filtering said anonymous identifiers based on location constraints.

39. A system according to claim 36, wherein said profiling processor comprises a profile filter for filtering anonymous identifiers based on a set of constraints defined by said anonymous profile.
